(19) United States
(12) Patent Application Publication
(10) Pub. No.: US 2026/0218632 A1
(43) Pub. Date: Jul. 30, 2026

(54) HYDRAULIC CONTROL VALVE AND METHOD OF CONTROLLING A HYBRID CAM PHASER

(71) Applicant: Cummins Inc., Columbus, IN (US)

(72) Inventors: Gabriel S. ROBERTS, Wallingford, CT (US); Kyle WEBB, Oxfordshire (GB); Mark WALTON, Northamptonshire (GB); John T. SNYDER, Irving, TX (US)

(21) Appl. No.: 19/461,509

(22) Filed: Jan. 27, 2026

Related U.S. Application Data
(60) Provisional application No. 63/750,122, filed on Jan. 27, 2025.

(51) Int. Cl. F01L 1/344

(52) U.S. Cl. CPC F01L 1/3442; F01L 2001/34426; F01L 2001/3445

(57) ABSTRACT

For a cam phaser capable of selectively operating in a CTA, OPA or maintenance mode of operation, a method of controlling the cam phaser comprises determining that a new engine operating state for the internal combustion engine is required, and further determining that a new cam phaser state is to be used to achieve the new engine operating state. The method further comprises switching operation of the cam phaser to the CTA mode to effectuate transition to the new cam phaser state. In an embodiment, while operating in the CTA mode, if the new cam phaser state has not been achieved, the method further comprises switching operation of the cam phaser to the OPA mode to effectuate transition to the new cam phaser state. A hydraulic control valve in accordance with such operation comprises a shuttle valve having a pair of opposed check valves disposed in a bore formed therein.

### FIELD

The present disclosure generally concerns internal combustion engines and, in particular, the use of cam phasers in such engines. Even more particularly, the instant disclosure concerns a hydraulic control valve and a method of controlling a hybrid cam phaser.

### BACKGROUND

As well known in the art, internal combustion engines typically comprise a plurality of combustion chambers referred to as cylinders. In turn, each cylinder typically comprises one or more intake engine valves and one or more exhaust engine valves. In their most basic operation, such intake valves are cyclically actuated to control the flow of fresh air into each cylinder in support of fuel combustion, whereas such exhaust valves are also cyclically actuated to control the flow of fuel combustion products out of the cylinders. Such cyclical actuations are typically controlled by a plurality of cams (in conjunction with intervening valvetrains) having fixed cam surfaces rotating about a camshaft, the rotation of which is synchronized to rotations of the internal combustion engine's crankshaft.

Cam phasing refers to technologies that provide the ability to change the opening or lift timing of intake and/or exhaust engine valves, thereby often providing significant emissions reduction and fuel economy benefits. To do this, as known in the art, cam phasers alter the timing of rotation of the camshaft (and, consequently, the cams) relative to the crankshaft. A highly simplified example of a cam phaser 100 is illustrated in FIG. 1. In particular, the cam phaser 100 comprises a stator 110 and a rotor 130, where the stator 110 is operatively connected to the engine crankshaft and the rotor 130 is operatively connected to the camshaft (intake or exhaust), as known in the art. Respective vanes 112, 132 formed on the stator 110 and rotor 130 are configured such that they form cavities 152, 154. Hydraulic fluid (typically, engine oil) can be selectively supplied to one of the cavities 152, 154 while hydraulic fluid from the other of the cavities 152, 154 is evacuated. Through this provision of relatively locked volumes of hydraulic fluid, the positioning of the rotor 130 relative to the stator 110 can be controlled and, as a consequence, timing of camshaft lobes on the camshaft may be advanced or retarded relative to the set timing established by the crankshaft.

While cam phasing has been used in the passenger car market for many years, it is just now seeing use in medium-duty (MD) and heavy-duty (HD) commercial vehicles as emissions regulations tighten and fuel economy becomes a key differentiator.

Adapting cam phasing to MD and HD commercial vehicles is challenging because of the loads and torques typically applied to valvetrains, and the cam phaser itself, in such vehicles. They are significantly higher than passenger car applications and need to be considered in the overall design of a valve actuation system. This is particularly true in valve actuation systems designed to implement engine braking mode operation of the engine when valvetrains see the highest load (whereby, as known in the art, the engine is operated as an air compressor system to absorb momentum from a vehicle).

While there are many types of cam phasers, the leading technologies for adoption in commercial vehicles (and considered standard in the automotive/passenger car space) are so-called Oil Pressure Actuated (OPA) or Cam Torque Actuated (CTA) technologies.

OPA phasers traditionally use hydraulic fluid (oil) pressure ported to one side of the rotor vanes to move the rotor relative to the stator, with the other side of the vanes vented to a reservoir (such as the crank case or tank in the case of engine oil). For example, and with reference once again to FIG. 1, if it is desired to retard (delay) engine valve lift timing, pressurized hydraulic fluid may be supplied to the first or retard cavity 152 while fluid in the second or advance cavity 154 is vented. The resulting pressure differential between the respective cavities 152, 154 causes the rotor 130 to rotate clockwise (as illustrated) relative to the stator 110. On the other hand, operation providing opposite hydraulic fluid supplying/venting of the cavities 152, 154 results in advancing (earlier) engine valve lift timing. OPA phasers have good response time, especially at low temperatures, as venting of one of the cavities 152, 154 permits pressure across the rotor vane 132 to be maximized. However, OPA phasers can struggle to operate during high torque engine operation (for example, during engine braking mode) because pressurization of hydraulic fluid received from the engine oil supply may be low relative to the forces being applied to the camshaft and, therefore, the rotor 130. Also, under high torque conditions, there is more hydraulic fluid leakage in the phaser 100 that needs to be refilled. However, it is often the case that the oil supply from the engine may not be adequate to refill the phaser in the allowed time, thereby causing issues like cavitation.

In contrast, CTA phasers traditionally use a combination of oil pressure received from the engine oil supply and engine oil that is recirculated from the vented cavity side of the rotor 130 to the supplied cavity side of the rotor 130. This allows a higher rate of pressure/flow to reach the supplied cavity for hydraulic refill after a high torque event, making the CTA phaser better technology for a high load/torque application like engine braking on a commercial vehicle engine. However, because the oil is partially recirculated, the pressure differential across the rotor vane is not maximized and, under low temperature operation, such low differential pressure can lead to very slow response times.

Therefore, provision of a cam phaser system that provides the benefits of both OPA and CTA cam phaser technologies would represent a welcome addition to the art.

### SUMMARY

The instant disclosure describes a hydraulic control valve for use in a cam phaser. In particular, in one embodiment, such a hydraulic control valve comprises a housing having an axially extending central bore formed in the housing and having a radially extending first port configured for fluid communication with at least one retard cavity of the cam phaser and a radially extending second port configured for fluid communication with at least one advance cavity of the cam phaser. A shuttle valve is slidably disposed within the central bore and has an axially extending shuttle valve bore formed in the shuttle valve, the shuttle valve further having a central radial opening, a first lateral radial opening and a second lateral radial opening in fluid communication with the shuttle valve bore. A pair of opposed check valves are disposed in the shuttle valve bore. In a first mode of operation corresponding to at least one first mode position of the shuttle valve, hydraulic fluid flows through the first and second ports and does not flow through the shuttle valve bore. On the other hand, in a second mode of operation corresponding to at least one second mode position of the shuttle valve, hydraulic fluid flows through the first and second ports and the shuttle valve bore via one or more of the central radial opening, the first lateral radial opening or the second lateral radial opening, thereby causing at least one check valve of the pair of opposed check valves to open.

In an embodiment, the hydraulic control valve comprises a flow sleeve, disposed within the central bore, and having an axially extended closed bore formed in the flow sleeve, and further having a radially extending first routing port and a radially extending second routing port configured for fluid communication with the closed bore. In this case, the first and second routing ports are configured to align with respective ones of the first and second ports of the housing. Further this embodiment, the shuttle valve is disposed within the closed bore such that the first lateral radial opening is configured for selective fluid communication with the first routing port, the second lateral radial opening is configured for selective fluid communication with the second routing port, and the central radial opening is configured for selective fluid communication with either the first or second routing port. Further this embodiment, the housing comprises a fluid input opening in fluid communication with the central bore, and wherein the flow sleeve comprises an axially extending input fluid path and a radially extending input port in fluid communication with the input opening. In this case, the flow sleeve comprises a checking element housing supporting a checking element fluidly interposed between the fluid input opening and the fluid input path. Further still, the flow sleeve may comprise a radially extending output port and an axially extending output fluid path configured for fluid communication with the central bore.

A cam phaser may incorporate the hydraulic control valve described herein. Further, a vehicle may incorporate such a cam phaser.

In another embodiment, the instant disclosure describes a method of controlling a cam phaser of the type used in an internal combustion engine and configured to selectively operate according to a CTA mode of operation, an OPA mode of operation or a maintenance mode of operation. The method comprises determining that a new engine operating state for the internal combustion engine is required, and further determining that a new cam phaser state is to be used to achieve the new engine operating state. The method further comprises switching operation of the cam phaser to the CTA mode to effectuate transition to the new cam phaser state. While operating in the CTA mode, if the new cam phaser state has not been achieved, the method further comprises switching operation of the cam phaser to the OPA mode to effectuate transition to the new cam phaser state.

In an embodiment, while operating in the CTA mode and prior to switching operation of the cam phaser to the OPA mode, if the new cam phaser state has not been achieved, the method further comprise continuing to operate the cam phaser in the CTA mode.

In an embodiment, while operating in the CTA mode, if the new cam phaser state has been achieved, the method further comprises switching operation of the cam phaser to the maintenance mode to maintain the new cam phaser state.

In an embodiment, while operating in the OPA mode, if the new cam phaser state has not been achieved, the method further comprises continuing to operate the cam phaser in the OPA mode.

In an embodiment, while operating in the OPA mode, if the new cam phaser state has been achieved, the method further comprises switching operation of the cam phaser to the maintenance mode to maintain the new cam phaser state.

In all embodiments described herein, operating in the CTA mode further comprises operating in a CTA advance mode or a CTA retard mode. Likewise, operating in the OPA mode further comprises operating in an OPA advance mode or an OPA retard mode.

In another embodiment, wherein the cam phaser comprises a hydraulic control valve, the hydraulic control valve further comprising a housing having an axially extending central bore formed in the housing and having a radially extending first port configured for fluid communication with at least one retard cavity of the cam phaser and a radially extending second port configured for fluid communication with at least one advance cavity of the cam phaser; a shuttle valve slidably disposed within the central bore and having an axially extending shuttle valve bore formed in the shuttle valve, the shuttle valve further having a central radial opening, a first lateral radial opening and a second lateral radial opening in fluid communication with the shuttle valve bore; and a pair of opposed check valves disposed in the shuttle valve bore, the method further comprises switching operation of the cam phaser to the CTA mode by moving the shuttle valve to at least one CTA mode position of the shuttle valve such that hydraulic fluid flows through the first and second ports and the shuttle valve bore via one or more of the central radial opening, the first lateral radial opening or the second lateral radial opening, thereby causing at least one check valve of the pair of opposed check valves to open. Further this embodiment, the method further comprises switching operation of the cam phaser to the OPA by moving the shuttle valve to at least one OPA mode position of the shuttle valve such that hydraulic fluid flows through the first and second ports and does not flow through the shuttle valve bore.

### BRIEF DESCRIPTION OF THE DRAWINGS

The foregoing and other features and advantages will be discussed in detail in the following non-limiting description of specific embodiments in connection with the accompanying drawings, in which:

FIG. 1 illustrates a simplified cam phaser in accordance with prior art techniques;

FIG. 2 is a partial, perspective, exploded view of rotor and stator assemblies of a cam phaser in accordance with the instant disclosure;

FIGS. 3-5 are schematic illustrations of operation of a cam phaser in accordance with the instant disclosure;

FIG. 6 is a flow chart illustrating operation of a cam phaser in accordance with the instant disclosure;

FIG. 7 is a partial, perspective, exploded view of an oil control valve for use in a cam phaser in accordance with the instant disclosure;

FIGS. 8A-8D are cross-sectional views of a cam phaser in accordance with the instant disclosure configured to operate in an OPA mode; and

FIGS. 9A-9C are cross-sectional views of a cam phaser in accordance with the instant disclosure configured to operate in a CTA mode.

### DETAILED DESCRIPTION OF THE PRESENT EMBODIMENTS

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the phrase “operatively connected” refers to at least a functional relationship between two elements and may encompass configurations in which the two elements are directed connected to each other, i.e., without any intervening elements, or indirectly connected to each other, i.e., with intervening elements.

As used herein, the phrase “fluid communication” refers to a configuration between two or more elements in which fluid is able to flow in at least one direction between such elements.

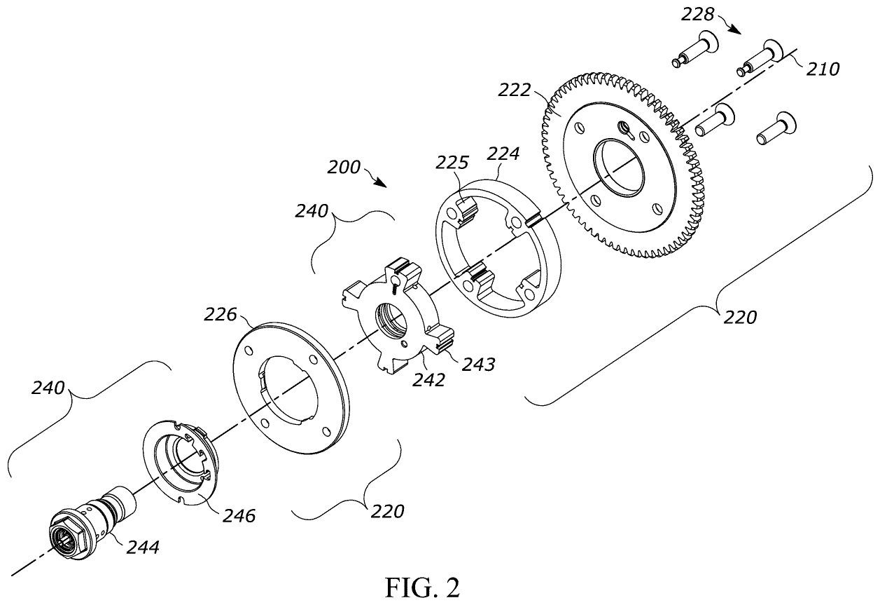

Referring now to FIG. 2, a simplified depiction of a cam phaser 200 comprises a stator assembly 220 and a rotor assembly 240. As known in the art, the stator assembly 220 is configured to be operatively connected to a crankshaft (i.e., a fixed-time source relative to rotations of a crankshaft for providing rotational movement to one or more camshafts; not shown). On the other hand, the rotor assembly 240 is configured to be operatively connected to a camshaft (not shown). As shown, all of the components of both the stator assembly 220 and the rotor assembly 240 are concentrically arranged about a longitudinal axis 210 of the cam phaser 200.

The stator assembly 220 comprises a camshaft drive gear 222, a stator 224 and front plate 226 all secured to each other in a stacked arrangement by suitable fasteners 228. In the illustrated embodiment, the camshaft drive gear 222 comprises gear teeth along its outer circumference configured to be linked via a suitable timing chain, gear or belt to the crankshaft. In this manner, rotational movement applied to the camshaft gear drive 222 results in corresponding rotation of the entire stator assembly 220. The stator 224 comprises a plurality of vanes 225 equally spaced circumferentially about and radially extending inwardly from an inner diameter of the stator 224.

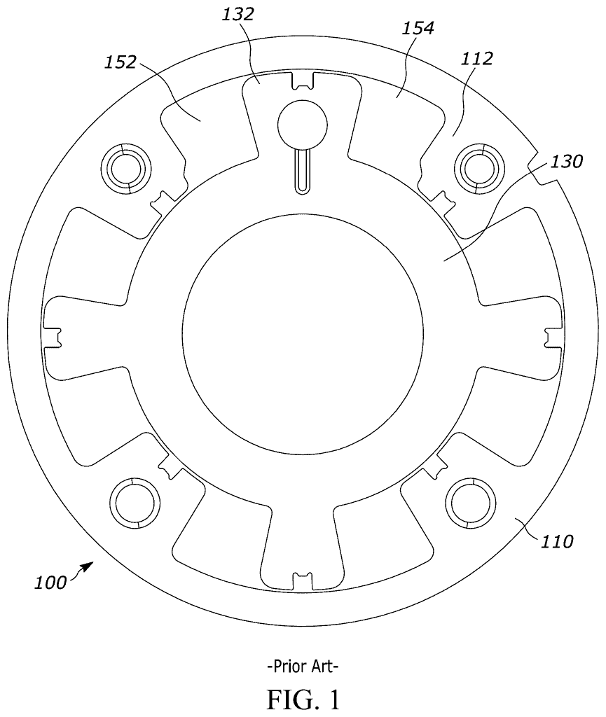

The rotor assembly 240 comprises a rotor 242, a bias spring retainer 246 and oil control valve 244. The rotor 242 comprises a plurality of vanes 243 (in same number as the stator vanes 225) radially extending outwardly. As shown, the rotor 242 fits into a fluid-tight space formed by the longitudinal thickness of the stator 224 while sandwiched between the camshaft drive gear 22 and the front plate 226. Within this space, vanes 243 of the rotor 242 establish hydraulic fluid cavities (as described above relative to FIG. 1) in conjunction with the vanes 225 of the stator 224. Although not shown, both the vanes 225 of the stator 224 and the vanes 243 of the rotor 242 will include fluid seals disposed at ends of each of the vanes 225, 243 that help prevent fluid leakage between the fluid cavities established by the vanes 225, 243.

The bias spring retainer 246 is provided to ensure proper alignment of a bias spring (not shown) configured to provide a preload bias between the stator assembly 220 and the rotor assembly 240 thereby decreasing the average torque applied to the camshaft, which might otherwise tend to favor movement of the rotor 242 to a fully retarded position relative to the stator 224. The oil control valve 244, as described in further detail below, is provided to selectively apply hydraulic fluid to the hydraulic fluid cavities between the stator 224 and rotor 242 to control advancing/retarding of the rotor 242 (and, therefore, the camshaft) as desired. In an embodiment, hydraulic passages formed in the rotor 242 may be provided to convey hydraulic fluid from the oil control valve 244 to the hydraulic fluid cavities between the stator 224 and rotor 224. Further, under the guidance of a control solenoid (not shown), operation of the oil control valve 244 may be regulated to switch operation of the cam phaser 200 between OPA and CTA operation, as described in further detail below.

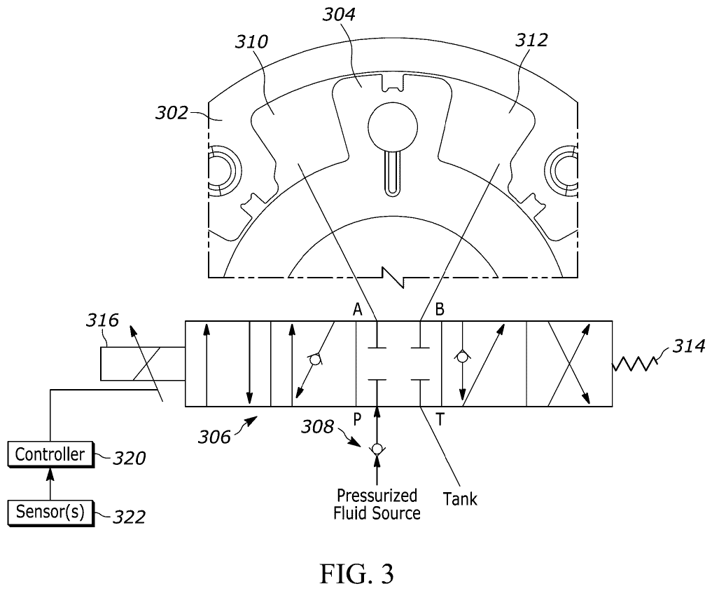

Referring now to FIGS. 3-5, operation of a cam phaser in accordance with the instant disclosure is further described. In FIGS. 3-5, operation of the control valve 244 is schematically illustrated using a five-position spool valve 306 that controls flow of hydraulic fluid to/from a retard cavity 310 and advance cavity 312 defined by respective vanes 302, 304 of a stator and rotor, as described above. Position of the spool valve 306 is controlled by a bias spring 314 at one end of the spool valve 306, and by a variable force solenoid 316 deployed at the other end of the spool valve 306. A controller 320, which may comprise an engine control unit or similarly-equipped processing device, is provided to control extension or retraction of a plunger configured to contact the spool valve 306, thereby controlling positioning of the spool valve 306 in conjunction with the bias spring 314. Additionally, one or more sensors 322 may be operatively connected to the controller 320 in order to provide sensor data that may be employed by the controller 320 when executing a control strategy for the spool valve 306. In this manner, the spool valve 306 may be laterally translated in its bore (not shown) so as to algin positions of the spool valve 306 as described below, particularly in response to specific operating conditions as determined by the sensor(s) 322.

Although FIGS. 3-5 illustrate 5 discrete positions that, as described below, implement various modes of operation of the cam phaser, it is understood that the distinctions between cam phaser operating modes are not as distinctly defined. That is, rather than operating in mutually independent modes such as OPA and CTA, cam phasers in accordance with the instant disclosure can operate in “blended” modes of operation in dependence upon the particular engine operation sought to be achieved as dictated by the phasing of the camshaft, along with the current operational state of the engine. In other words, the various operating modes of the cam phaser may be thought of as a hierarchy of options that may be employed to achieve a desired camshaft phasing. For example, if desired operation of the engine requires fully retarded positioning of the camshaft, operation of the cam phaser can be modified to first attempt to achieve the retarded phasing using a first cam phaser operating mode, e.g., CTA operation. If it is determined, through sensor readings conveying camshaft positioning, that the full retarded position has not be achieved, or at least not achieved quickly enough, operation of the cam phaser can be modified further to achieve the fully retarded phasing using a second cam phaser operating mode, e.g., OPA operation. Once the desired camshaft positioning has been achieved, further modifications of the cam phaser operation may be discontinued (and the current cam phaser state maintained) until such time that a different positioning of the camshaft is desired. Further details of such operation are described below.

Referring again to FIGS. 3-5, each of the positions of the spool valve 306 may be aligned with ports, labeled “A” and “B,” respectively connected to the retard cavities 310 and advance cavities 312, a fluid supply port, “P,” corresponding to the source of pressurized fluid for the engine; and vent port “T” corresponding to the crankcase or tank for venting of hydraulic fluid. Fluid to the supply port, P, is preferably supplied by the oil source for the engine, e.g., an oil pump. A check valve 308 is typically provided to prevent backflow from the cavities 310, 312 to the pressurized fluid source.

As depicted in FIG. 3, the spool valve 306 is positioned such that a central position thereof is aligned with the A/B/P/T ports. This central position, which may be deemed a “hold” or “maintenance” position, prevents flow of hydraulic fluid to or from any of A/B/P/T ports, thus providing a hydraulic lock on the cavities 310, 312 and thereby maintaining the rotor 304 is it current position relative to the stator 302, i.e., in a maintenance mode of operation. For example, once a desired positioning of the camshaft has been achieved (as determined by the sensors 322 and controller 320), the spool valve 306 may be controlled to assume the hold position, thereby maintaining the rotor 304 and the camshaft in the desired position.

As further depicted in FIGS. 3-5, on either side of the central or hold position, the spool valve 306 includes two CTA positions, i.e., positions that cause the cam phaser to operate in CTA mode and, at the ends of the spool valve 306 past the respective CTA positions, two OPA positions are provided, i.e., positions that cause the cam phaser in OPA mode. In the illustrated embodiment, the CTA and OPA positions to the right of the hold position (as depicted), when selected, operate to cause the rotor 304 to advance, i.e., to decrease fluid in the retard cavity 310 and increase fluid in the advance cavity 312. On the other hand, the CTA and OPA positions to the left of the hold position (as depicted) operate to cause the rotor 304 to retard, i.e., to increase fluid in the retard cavity 310 and decrease fluid in the advance cavity 312. Of course, it is appreciated that the manner in which the respective CTA/OPA positions advance or retard the rotor 304 will differ in accordance with the hydraulic fluid management strategy distinctions between CTA and OPA operation as described above.

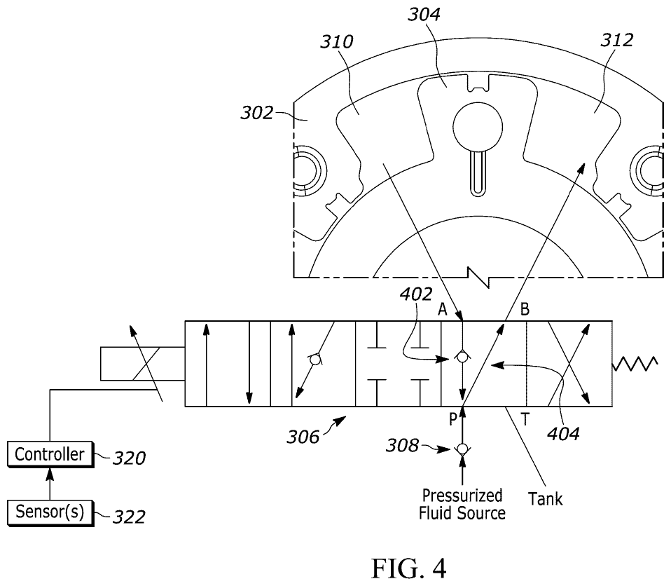

Thus, with reference to FIG. 4, positioning of the spool valve 306 by the controller 320 has been modified such that the spool valve 306 has translated in a leftward direction (as depicted), thereby positioning the CTA advance position to align with the A/B/P/T ports, as shown. In this case, the A port is aligned with a fluid connection to the P port via a first internal check valve 402, and the B port is aligned with another fluid connection 404 to the P port and the A port (again, via the first internal check valve 402). In this manner, and as depicted by the flow arrows, hydraulic fluid is allowed to flow from the P port to the B port, thereby filling the advance cavity 312. At the same time, the torque load applied to the rotor 304 acts upon the retard cavity 310 such that hydraulic fluid is pressurized and forced out of the retard cavity 310, through the first internal check valve 402 into the other fluid connection 404 to further assist with filling of the advance cavity 312.

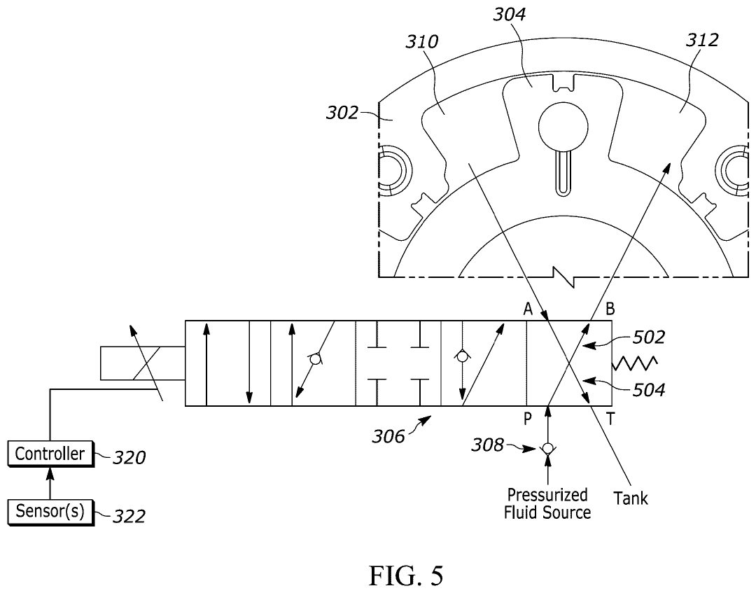

In turn, further leftward translation of the spool valve 306 (as commanded by the controller 320) causes the OPA advance position to align with the A/B/P/T ports, as shown in FIG. 5. In this case, the A port is aligned with a fluid connection 504 to the crankshaft or tank, T, port, and the B port is aligned with another fluid connection 502 to the P port. In this manner, and as depicted by the flow arrows, hydraulic fluid is allowed to flow from the P port to the B port, thereby filling the advance cavity 312. At the same time, pressurized fluid in the retard cavity 310 is allowed to vent to the tank port T.

As schematically depicted, both the CTA retard position (to the immediate left of the hold position) and the OPA retard position (to the left of the CTA retard position) are equipped with fluid connections (and in the case of the CTA retard position, a second internal check valve) that effectively reverse the fluid flows relative to the CTA advance position and OPA advance position described above relative to FIGS. 4 and 5. Thus, those skilled in the art will appreciate, the controller 320 may be operated to position the spool valve 306 to align either the CTA retard position or OPA retard position with the A/B/P/T ports in order to effectuate the desired operation.

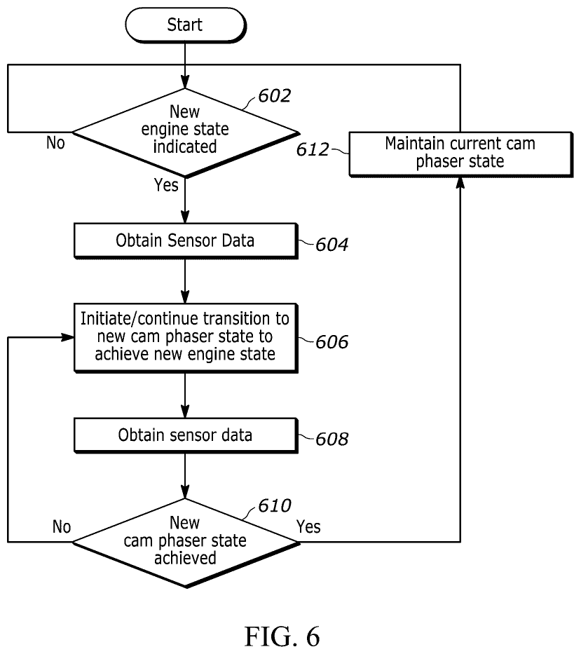

Referring now to FIG. 6, a flowchart is illustrated showing operation as implemented by a controller, such as the controller 320 depicted in FIGS. 3-5. For example, where the controller is implemented as a processing device operating according to stored instructions, the processing illustrated in FIG. 6 may be implemented using such stored instructions using techniques known in the art. Thus, beginning at block 602, a determination is continuously made whether a new engine operating state is required. Techniques for making such a determination are known. By way of non-limiting example, at engine startup, when engine temperature is low and oil viscosity is high (as determined by appropriate sensors), it is desirable to operate some or all of the exhaust engine valves of the engine in accordance with early exhaust valve opening (EEVO) techniques. Once the desired engine temperatures (and, often, exhaust aftertreatment temperatures) have been achieved, it may be desirable to switch back to normal (i.e., unmodified) engine valve operation. Other examples of desired engine operating states include late intake valve closing (LIVC) or compression-release engine braking. Still further engine operating states may be evident to those skilled in the art.

If the need to transition to a new engine operating state has been determined at block 602, processing continues at block 604 where the controller obtains data from one or more sensors, which may include one or more sensors for detecting camshaft and crankshaft positions, temperature of the engine, oil pressure, etc. As known in the art, the process of obtaining such sensor data may be performed continuously at any desired interval or may be done on a pull basis whereby such sensor data is only obtained when requested.

Having obtained sensor data, processing continues at block 606 where a determination is made about what changes, if any, need to be made to place the cam phaser in a new operating state in order achieve the desired engine operating state, and then initiating or continuing transition of the cam phaser operating state as needed. For example, and with reference to FIGS. 4 and 5, if the new engine operating state requires full advancement of the cam phaser, the spool valve 306 is first controlled to transition to the CTA advance position as shown in FIG. 4. In a presently preferred embodiment, when initiating transition to a new cam phaser state, CTA operation is attempted before OPA operation. Stated another way, when transitioning away from maintenance operation of the cam phaser, the control scheme of FIG. 6 will first attempt to achieve the new cam phaser state using CTA operation (whether advance or retard). This approach is preferred in the case of MD and/or HD vehicles where a greater chance exists for sufficiently high torque loads being applied to cam phaser.

Referring again to FIG. 6, at block 608, the controller once again obtains data from one or more sensors and, thereafter, a determination is made at block 610, whether the new cam phaser state (again, required to achieve the desired engine operating state) has been reached. For example, and with further reference to the noted camshaft advancement example, the sensor data obtained at block 608 may include camshaft position data that may be assessed to determine if the camshaft has reached full advancement. In practice, the processing of blocks 608 and 610 may occur within a certain period of time following instantiation of the processing block 606, e.g., within a predetermined number of engine cycles.

Regardless, if the determination at block 610 indicates that the new cam phaser state has not yet been achieved, processing continues at block 606 where the transition to the new cam phaser operating state is continued. Based on the negative determination made at block 610, it may be inferred that the initial change to CTA operation has been and will continue to be insufficient to achieve the desired advancement. In this case, and continuing the previous example, the spool valve 306 may be further controlled to continue its transition from the CTA advance to the OPA advance position as shown in FIG. 5. This may be the case, for example, where the torque currently applied by the crankshaft to the stator is too low to provide a sufficient pressure differential between the advance cavity 312 and the retard cavity 310. By switching operation of the spool valve 306 to the OPA advance position, a greater pressure differential between the advance cavity 312 and the retard cavity 310 may be incurred, thereby facilitating quicker completion of the transition of the cam phaser to the fully advanced state. Alternatively, based on the negative determination made at block 610, it may instead be inferred that the initial change to CTA operation will be sufficient to achieve the desired advancement, in which case operation at block 606 will continue with CTA operation (i.e., prior to attempting to switch to OPA operation). This may be the case, for example, where the torque currently applied by the crankshaft to the stator is sufficiently high that completion of the desired transition to the new cam phaser state will be better achieved by continuing with CTA operation rather than switching to OPA operation.

On the other hand, if the determination at block 610 indicates that the new cam phaser state has been achieved, whether through CTA operation or OPA operation, processing continues at block 612 where the cam phaser is controlled to maintain the current (i.e., the newly achieved) cam phaser operating state. For example, the spool valve 306 is controlled to transition to the hold position as illustrated in FIG. 3, whereby the trapped fluid volume in the advance cavity 312 and/or the retard cavity 310 is maintained in its current state. Thereafter, processing continues once again at block 602 such that the cam phaser is maintained in its current state until the determination at block 602 indicates that another new engine operating state is required.

In the description of FIG. 6 above, the example requiring use of CTA and/or OPA advance operation was used. However, those skilled in the art will appreciate that the processing of FIG. 6 is equally applicable to the use of CTA and/or OPA retard operation.

As noted above, while the cam phaser operating states are illustrated in FIGS. 3-5 as discrete, mutually exclusive states, in practice, this is not necessarily the case. Thus, control of the spool valve 306 in accordance with blocks 606-610 may effectuate partial or overlapping operation of cam phaser states. That is, in order to achieve the desired engine operating state (e.g., advancement or retardation of the camshaft by only a few degrees), it may be necessary to only partially engage the CTA advance or retard position of the spool valve before entering the maintenance condition at step 612. Similarly, if the CTA advance or retard position of the spool valve is insufficient to achieve the desired state, continued advancement of the spool valve may establish simultaneous CTA and OPA operation sufficient to achieve the desired state. Further description of such operation is provided below. Additionally, while the description of FIG. 6 included the example of transitioning cam phaser operation to fully advanced, those skilled in the art will appreciate that the processing illustrated in FIG. 6 can be equally applied to transitions to less than a fully advanced state, or to any desired retarded state as needed.

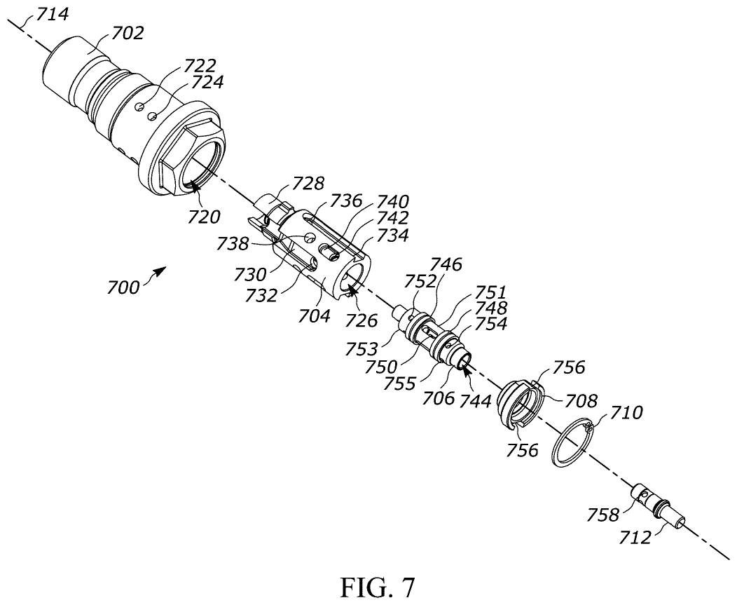

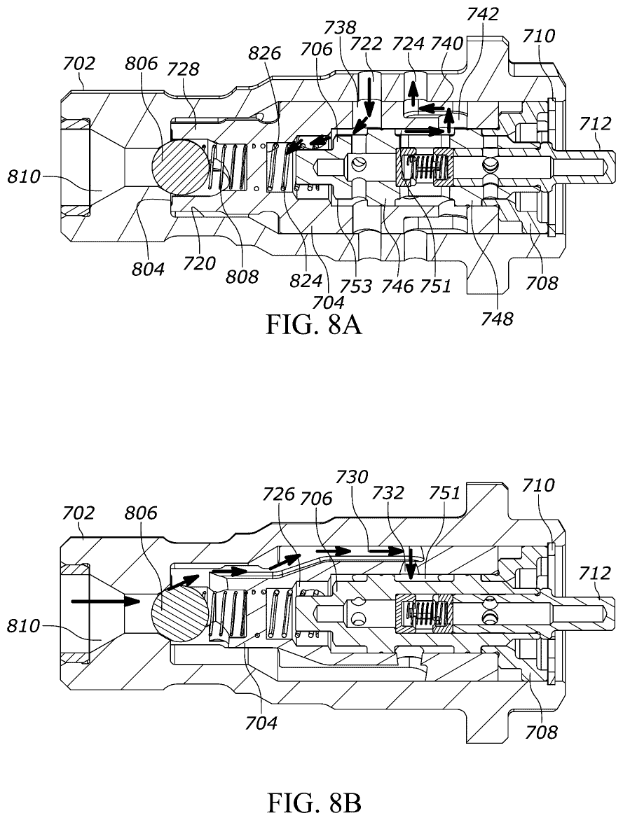

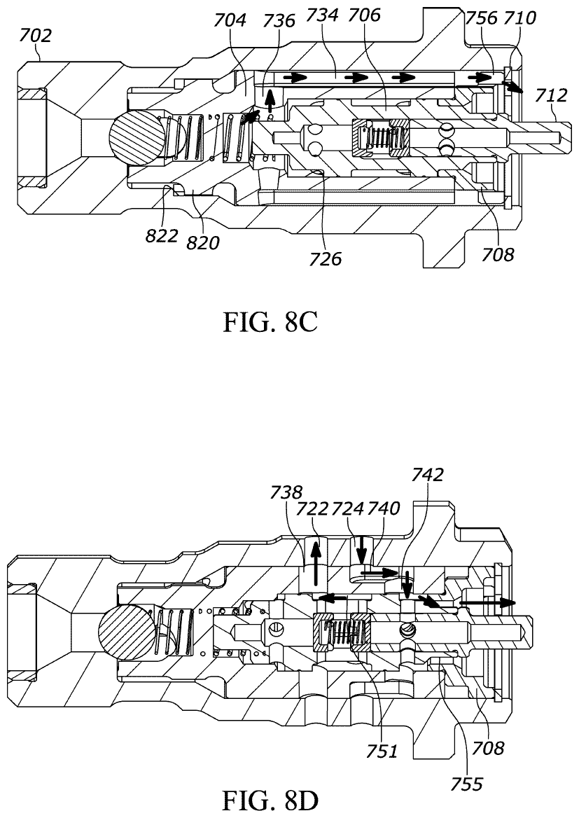

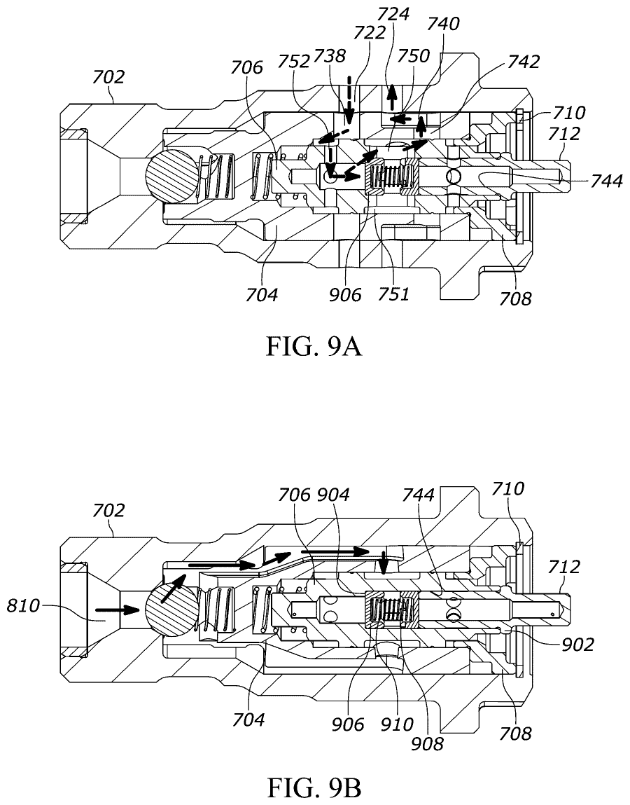

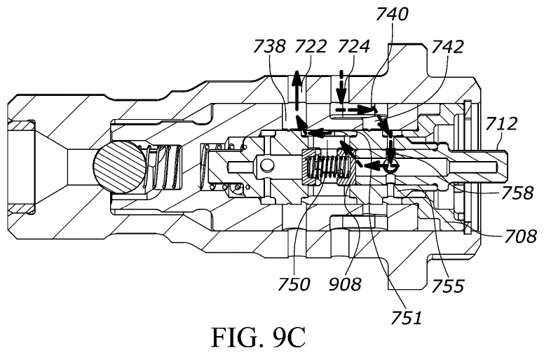

Referring now to FIGS. 7-9, the structure and operation of an oil control valve 700 according to embodiments of the instant disclosure is described in further detail. In particular, the oil control valve 700 implements the functionality of the spool valve 244, 306 described above. With reference to FIG. 7, a simplified, exploded view of the oil control valve 700 illustrates a control valve housing 702, a flow sleeve 704, shuttle valve 706, shuttle stop 708, snap ring 710 and shuttle control pin 712, all concentrically arranged about a longitudinal axis 714 of the oil control valve 700. Various other components included in the oil control valve 700, but not illustrated in FIG. 7, are further illustrated in and described with reference to FIGS. 8 and 9.

The control valve housing 702 has the general shape of a cylinder having a central bore 720 formed therein and configured to receive the flow sleeve 704. The flow sleeve 704 comprises a closed bore 726 configured to receive the shuttle valve 706 that, in turn, comprises a closed bore 726 configured to receive the shuttle control pin 712. As shown, the housing 702 comprises two radially extending openings 722, 724, respectively corresponding to the A and B ports described above relative to FIGS. 3-5. As best shown in FIGS. 8 and 9, particularly FIG. 8A, the central bore 720 receives the flow sleeve 704 up to a point where a check element housing or check valve boss 728 formed at an end of the flow sleeve 704 abuts a shoulder 804 formed in the interior of the housing 702. The shuttle stop 708 and check ring 710 (which resides in an annular notch formed in the interior surface of the central bore 720) retain the flow sleeve 704 in its longitudinal position in abutment with the shoulder 804. The shoulder 804 also forms a seat for a checking element (i.e., a check ball seat) for a checking element (e.g., check ball) 806 that may be biased by a check ball spring 808. In this manner, one-way flow of hydraulic fluid through a fluid input opening 810 and into the oil control valve 700 is provided. It is appreciated that a checking mechanism other than a check ball 806 (e.g., a check disk, etc.) may be equally employed for this purpose.

The flow sleeve 704, in cooperation with the interior surface of the central bore 720, operates to route incoming hydraulic fluid through the shuttle valve 706 toward the respective A and B ports 722, 724 and, similarly, to route hydraulic fluid received from either the A or B ports 722, 724 through the shuttle valve 706 back to one of the A or B ports 722, 724 or to vent such hydraulic fluid. To this end, the flow sleeve 704 comprises, in the illustrated embodiment, a pair of longitudinally-extending (i.e., parallel to the longitudinal axis 714) input fluid paths 730 formed on an exterior surface of the flow sleeve 704 (only one input fluid path 730 shown in FIG. 7; with the other being diametrically disposed on the other side of the flow sleeve 704). The input fluid paths 730 extend from the periphery of the check valve boss 728 to somewhat past a center point of the flow sleeve 704, where each of the input fluid paths 730 is terminated by a radially-extending input port 732 (one shown) that provides fluid communication with the closed bore 726 (as best shown in FIGS. 8B and 8C).

Similarly, the flow sleeve 704 also comprises, in the illustrated embodiment, a pair of longitudinally-extending output fluid paths 734 formed on the exterior surface of the flow sleeve 704 (only one output fluid path 734 shown in FIG. 7; with the other being diametrically disposed on the other side of the flow sleeve 704). In an embodiment, a plane including the longitudinal axis 714 and bisecting both of the input fluid paths 730 is orthogonal to a plane also including the longitudinal axis 714 and bisecting both of the output fluid paths 734. The output fluid paths 734 extend from the periphery of distal end (relative to the check element housing 728) of the flow sleeve 704 somewhat past the approximate center point of the flow sleeve 704, where the output fluid paths 734 are terminated by a radially-extending output port 736 (one shown) that also provides fluid communication with the closed bore 726 (as best shown, again in FIG. 8C). In order to complete a flow path out of the oil control valve 700, and as best shown in FIGS. 7 and 8C, the shuttle stop 708 comprises a pair of notches 756 configured to align with the output fluid paths 734 and having the same depth and width as the output fluid paths 734. A frictional engagement between the shuttle stop 708 and the flow sleeve 704 prevents rotation therebetween.

As further shown in FIG. 7, the flow sleeve 704 comprises a first routing port 738 that radially extends from the exterior to the interior of the flow sleeve 704, and that is configured to align with the A port 722 (as best shown in FIGS. 8A and 9A). Additionally, a second routing circuit 740 is formed as a longitudinally-extending notch formed in the outer surface of the flow sleeve 704. The second routing circuit 740 is configured to align with the B port 724, and is terminated at an end thereof by a second routing port 742 that radially extends from the exterior to the interior of the flow sleeve 704. As described in greater detail below, the first routing port 738 and the second routing circuit 740/second routing port 742 respectively operate to route hydraulic fluid to/from the A port 722 and B port 724 to various locations within the oil control valve 700 as dictated by the shuttle valve 706.

As seen in FIG. 8C, the flow sleeve 704 may comprise a radially-extending key bump or protrusion 820 and the interior surface of the central bore 720 may comprise a matingly configured keyway 822 such that engagement of the key 820 with the keyway 822 prevents rotation of the flow sleeve 704 relative to the housing 702. In this manner, along with the longitudinal maintenance of the flow sleeve 704 within the housing 702, continuous alignment of the first routing port 738 with the A port 722, as well as alignment of the second routing circuit 740 with the B port 724 is ensured.

As noted, the configuration of the fluid paths 730, 734 in conjunction with an interior surface of the housing 702 results in the formation of hydraulic flow paths, whereas the first routing port 738 and second routing circuit 740/second routing port 742 are consistently aligned with the A and B ports 722, 724. In essence, the provision of the flow sleeve 704 facilitates the necessary hydraulic flows into an out of the housing 702. However, though not preferred, it may be possible to form the necessary hydraulic flows directly into and out of the housing 702 without the addition of the flow sleeve 704. In this case, the further operation of the shuttle valve 706, described below, could be relative only to the housing 702 and not the combination of the housing 702 and flow sleeve 704.

The shuttle valve 706 is a spool valve having, in this implementation, a pair of lands 746, 748 separating three grooves comprising a central groove 751 and two lateral grooves 753, 755. As shown in FIGS. 8 and 9, the shuttle valve 706 is slidably disposed within the closed bore 726 and is biased out of the closed end bore 726 by a shuttle valve spring 824 disposed in a closed end 826 of the closed end bore 726. As best shown in FIG. 9B, the shuttle control pin 712 is inserted in a shuttle valve bore 744 formed in the shuttle valve 706 at an end of the shuttle valve 706 opposite the shuttle valve spring 824. The shuttle control pin 712 comprises a shoulder 902 that limits travel of the shuttle control pin 712 into the bore 744. As also best shown in FIG. 9B, a distal end (within the bore 744) of the shuttle control pin 712, in combination with a shoulder 904 formed in the bore 744, form a cavity in which a pair of internal check valves 906, 908 are deployed. As shown, the check valves 906, 908 are biased apart from each other by an internal check valve spring 910. As best shown in FIGS. 7, 8A and 9A, the cavity thus formed, as well as the assembly of the internal check valves 906, 908 and internal check valve spring 910, longitudinally aligns with the central groove 751 of the shuttle valve 706. A central radial opening 750, first and second lateral radial openings 752, 754 and a control pin radial opening 758 are respectively provided in the shuttle valve 706 and control pin 712 as shown and, as described below, are used to route fluid during CTA operation from one of the A or B ports in fluid communication with one of the advancing or retarding cavity to the other of the A or B ports in fluid communication with the other of the advancing or retarding cavity.

Referring now to FIGS. 8A-8D, operation of the oil control valve in OPA mode is illustrated. It is noted that: in FIGS. 8A and 8D, the illustrated section plane passes through the longitudinal axis 714 while bisecting the A and B ports 722, 724; in FIG. 8B, the illustrated section plane passes through the longitudinal axis 714 while bisecting the input flow paths 730; and in FIG. 8C, the illustrated section plane passes through the longitudinal axis 714 while bisecting the output flow paths 734.

Additionally, though not depicted in FIGS. 8A-8D (or FIGS. 9A-9C), the oil control valve depicted therein may be controlled to achieve a maintenance or hold mode of operation. In particular, this is achieved by controlling position of the shuttle valve 706 such that the lands 746, 748 substantially occlude, and therefore respectively prevent the flow of hydraulic fluid through, the first routing port 736 and the second routing port 742. That is, while some fluid may still leak through the first and second routing ports 740, 742 when the shuttle valve 706 is positioned in this manner, any such flow remains insufficient to alter operation of the cam phaser.

In an embodiment, a variable stroke solenoid (not shown) is provided that can actuate the shuttle control pin 712 and, in combination with the shuttle valve spring 824, thereby adjust positioning (leftward and rightward, as depicted) of the shuttle valve 706. In particular, in FIGS. 8A-8C, the shuttle valve 706 is positioned to implement OPA operation of the cam phaser, specifically advancement of the cam phaser, whereas in FIG. 8D, the shuttle valve 706 is positioned to implement retardation of the cam phaser during OPA operation. Additionally, in FIGS. 8A-8D, the flow of hydraulic fluid is illustrated with unbroken heavy arrows. Although the fluid flows in the FIGs. are illustrated, for ease of illustration, along single paths, e.g., the uppermost input fluid path 730, it is appreciated that such flows also occurs in the corresponding and opposite paths established within the oil control valve 700.

Thus, in FIG. 8B, hydraulic fluid is shown entering the housing 702 via the fluid input opening 810, flowing past the check ball 806 and into the input fluid paths 730. The hydraulic fluid then flows from the input fluid paths 730, through the input ports 732 and, as further shown in FIG. 8A, into the central groove 751 of the shuttle valve 706. Positioning of the shuttle valve 706 establishes an opening between the central groove 751 and the second routing port 742 such that the hydraulic fluid is able to flow out of the central groove 751, into the second routing port 742, the second routing circuit 740 and the B port 724 as shown.

At the same time, as shown starting with FIG. 8A, hydraulic fluid is able to flow from the A port 722 into the first routing port 738. Again, positioning of the shuttle valve 706 establishes fluid communication between the first routing port 738 and a first lateral groove 753 of the shuttle valve 706, as well as between the first lateral groove 753 and the closed end bore 726. Thus, the hydraulic fluid received from the A port 722 flows into the closed end bore 726 where, with reference to FIG. 8C, it is further able to flow through the output ports 736, the output fluid paths 734 and notch 756, thereby venting to the crankcase or tank.

With reference to FIG. 8D, retardation of the cam phaser during OPA operation also relies on the flow of hydraulic fluid though the fluid input opening 810 as described relative to FIG. 8B. However, in this case, the shuttle valve 706 is positioned such that an opening is formed between the central groove 751 and the first routing port 738 such that the hydraulic fluid is able to flow out of the central groove 751, into the first routing port 738 and the A port 722, as shown.

At the same time, as further shown starting with FIG. 8D, hydraulic fluid is able to flow from the B port 724 into the second routing circuit 740 and the second routing port 742. Again, positioning of the shuttle valve 706 establishes fluid communication between the second routing port 742 and a second lateral groove 755 of the shuttle valve 706, and additionally establishes fluid communication from the second lateral groove 755 to a space between the shuttle valve 706 and the shuttle stop 708 to the environment. Thus, the hydraulic fluid received from the B port 724 flows through the second routing circuit 740, the second routing port 742 and past the second lateral groove 755 and shuttle stop 708, thereby venting to the crankcase or tank.

On the other hand, in FIGS. 9A and 9B, the shuttle valve 706 is positioned to implement CTA operation of the cam phaser, specifically, once again, advancement of the cam phaser, whereas in FIG. 9C, the shuttle valve 706 is positioned to implement retardation of the cam phaser during CTA operation. Thus, in FIG. 9B, hydraulic fluid is shown entering the housing 702 via the fluid input opening 810, flowing past the check ball 806 and into the input fluid paths 730. From there, the hydraulic fluid flows from the input fluid paths 730, through the input ports 732 and, as further shown in FIG. 9A, into the central groove 751 of the shuttle valve 706. Positioning of the shuttle valve 706 establishes an opening between the central groove 751 and the second routing port 742 such that the hydraulic fluid is able to flow out of the central groove 751, into the second routing port 742, the second routing circuit 740 and the B port 724 as shown.

At the same time, as shown in FIG. 9A, hydraulic fluid is able to flow from the A port 722 into the first routing port 738 (shown with the heavy dashed arrows). Again, positioning of the shuttle valve 706 establishes fluid communication between the first routing port 738 and the first lateral groove 753. However, in this case, the positioning of the shuttle valve 706 prevents flow from the first lateral groove 753 into the closed end bore 726, and instead only permits fluid flow through the first check valve port 752, past the first internal check valve 906 and into the central groove 751. There, the fluid from the A port 722 is able to mix with the fluid from the fluid input opening 810 to aid supplying hydraulic fluid to the B port 724.

With reference to FIG. 9C, retardation of the cam phaser during CTA operation also relies on the flow of hydraulic fluid though the fluid input opening 810 as described relative to FIG. 8B. However, in this case, the shuttle valve 706 is positioned such that an opening is formed between the central groove 751 and the first routing port 738 such that the hydraulic fluid is able to flow out of the central groove 751, into the first routing port 738 and the A port 722, as shown. At the same time, as further shown in FIG. 9C, hydraulic fluid is able to flow from the B port 724 into the second routing circuit 740 and the second routing port 742 (shown with the heavy dashed arrows). In this case, positioning of the shuttle valve 706 establishes fluid communication between the second routing port 742 and the second lateral groove 755. However, in this case, the positioning of the shuttle valve 706 prevents flow from the second lateral groove 755 past the shuttle stop 708, and instead only permits fluid flow through the second check valve port 754 and control pin radial opening 758, past the second internal check valve 908 and into the central groove 751. There, the fluid from the B port 724 is able to mix with the fluid from the fluid input opening 810 to aid supplying hydraulic fluid to the A port 722.

While the various embodiments in accordance with the instant disclosure have been described in conjunction with specific implementations thereof, it is evident that many alternatives, modifications and variations will be apparent to those skilled in the art.

What is claimed is:

1. A method of controlling a cam phaser of the type used in an internal combustion engine, the cam phaser configured to selectively operate according to a cam torque actuated (CTA) mode of operation, an oil pressure actuated (OPA) mode of operation or a maintenance mode of operation, the method comprising:
determining a new engine operating state for the internal combustion engine is required;
determining a new cam phaser state to be used to achieve the new engine operating state;
switching operation of the cam phaser to the CTA mode to effectuate transition to the new cam phaser state; and
while operating in the CTA mode, if the new cam phaser state has not been achieved, switching operation of the cam phaser to the OPA mode to effectuate transition to the new cam phaser state.

2. The method of claim 1, further comprising:
while operating in the CTA mode and prior to switching operation of the cam phaser to the OPA mode, if the new cam phaser state has not been achieved, continuing to operate the cam phaser in the CTA mode.

3. The method of claim 1, further comprising:
while operating in the CTA mode, if the new cam phaser state has been achieved, switching operation of the cam phaser to the maintenance mode to maintain the new cam phaser state.

4. The method of claim 1, further comprising:
while operating in the OPA mode, if the new cam phaser state has not been achieved, continuing to operate the cam phaser in the OPA mode.

5. The method of claim 1, further comprising:
while operating in the OPA mode, if the new cam phaser state has been achieved, switching operation of the cam phaser to the maintenance mode to maintain the new cam phaser state.

6. The method of claim 1, wherein operating in the CTA mode further comprises operating in a CTA advance mode or a CTA retard mode.

7. The method of claim 1, wherein operating in the OPA mode further comprises operating in an OPA advance mode or an OPA retard mode.

8. The method of claim 1, wherein the cam phaser comprises a hydraulic control valve, the hydraulic control valve further comprising a housing having an axially extending central bore formed in the housing and having a radially extending first port configured for fluid communication with at least one retard cavity of the cam phaser and a radially extending second port configured for fluid communication with at least one advance cavity of the cam phaser; a shuttle valve slidably disposed within the central bore and having an axially extending shuttle valve bore formed in the shuttle valve, the shuttle valve further having a central radial opening, a first lateral radial opening and a second lateral radial opening in fluid communication with the shuttle valve bore; and a pair of opposed check valves disposed in the shuttle valve bore,
wherein switching operation of the cam phaser to the CTA mode further comprises moving the shuttle valve to at least one CTA mode position of the shuttle valve such that hydraulic fluid flows through the first and second ports and the shuttle valve bore via one or more of the central radial opening, the first lateral radial opening or the second lateral radial opening, thereby causing at least one check valve of the pair of opposed check valves to open.

9. The method of claim 8, wherein switching operation of the cam phaser to the OPA mode further comprising moving the shuttle valve to at least one OPA mode position of the shuttle valve such that hydraulic fluid flows through the first and second ports and does not flow through the shuttle valve bore.

10. A hydraulic control valve for use in a cam phaser, comprising:
a housing having an axially extending central bore formed in the housing and having a radially extending first port configured for fluid communication with at least one retard cavity of the cam phaser and a radially extending second port configured for fluid communication with at least one advance cavity of the cam phaser;
a shuttle valve slidably disposed within the central bore and having an axially extending shuttle valve bore formed in the shuttle valve, the shuttle valve further having a central radial opening, a first lateral radial opening and a second lateral radial opening in fluid communication with the shuttle valve bore; and
a pair of opposed check valves disposed in the shuttle valve bore,
wherein, in a first mode of operation corresponding to at least one first mode position of the shuttle valve, hydraulic fluid flows through the first and second ports and does not flow through the shuttle valve bore,
and wherein, in a second mode of operation corresponding to at least one second mode position of the shuttle valve, hydraulic fluid flows through the first and second ports and the shuttle valve bore via one or more of the central radial opening, the first lateral radial opening or the second lateral radial opening, thereby causing at least one check valve of the pair of opposed check valves to open.

11. The hydraulic control valve of claim 10, further comprising:
a flow sleeve, disposed within the central bore, and having an axially extended closed bore formed in the flow sleeve, and further having a radially extending first routing port and a radially extending second routing port configured for fluid communication with the closed bore,
wherein the first and second routing ports are configured to align with respective ones of the first and second ports of the housing.

12. The hydraulic control valve of claim 11, wherein the shuttle valve is disposed within the closed bore, and wherein the first lateral radial opening is configured for selective fluid communication with the first routing port, the second lateral radial opening is configured for selective fluid communication with the second routing port, and the central radial opening is configured for selective fluid communication with either the first or second routing port.

13. The hydraulic control valve of claim 11, wherein the housing comprises a fluid input opening in fluid communication with the central bore, and wherein the flow sleeve comprises an axially extending input fluid path and a radially extending input port in fluid communication with the input opening.

14. The hydraulic control valve of claim 13, wherein the flow sleeve comprises a checking element housing supporting a checking element fluidly interposed between the fluid input opening and the fluid input path.

15. The hydraulic control valve of claim 11, wherein the flow sleeve comprises a radially extending output port and an axially extending output fluid path configured for fluid communication with the central bore.

16. A cam phaser comprising the hydraulic control valve of claim 10.

17. An internal combustion engine comprising the cam phaser of claim 16.

18. A vehicle comprising the internal combustion engine of claim 17.
